(19) United States
(12) Patent Application Publication
(10) Pub. No.: US 2014/0226254 A1
(43) Pub. Date: Aug. 14, 2014

(54) CONDUCTIVE PASTE COMPOSITION, MULTILAYER CERAMIC CAPACITOR USING THE SAME, AND METHOD OF MANUFACTURING MULTILAYER CERAMIC CAPACITOR USING THE SAME

(71) Applicant: SAMSUNG ELECTRO-MECHANICS CO., LTD., Suwon (KR)

(72) Inventors: Young Ho KIM, Suwon (KR); Kyung Jin CHOI, Suwon (KR); Young Sik CHOI, Suwon (KR); Ji Hwan KIM, Suwon (KR); Dae Yu KIM, Suwon (KR); Ro Woon LEE, Suwon (KR)

(73) Assignee: SAMSUNG ELECTRO-MECHANICS CO., LTD., Suwon (KR)

(21) Appl. No.: 13/871,796

(22) Filed: Apr. 26, 2013

(30) Foreign Application Priority Data
Feb. 13, 2013 (KR) 10-2013-0015352

(51) Int. Cl. H01G 4/30; H01G 13/00; H01G 4/008

(52) U.S. Cl. CPC H01G 4/30; H01G 4/008; H01G 13/00
USPC 361/301.4; 252/512; 252/513; 252/514; 156/89.16; 156/89.14; 156/89.17; 156/89.18

(57) ABSTRACT

There are provided a conductive paste composition, a multilayer ceramic capacitor using the same, and a manufacturing method thereof. The conductive paste composition includes a conductive metal powder; a ceramic powder; and a resin, wherein the conductive paste composition has a theoretical density of 6 g/cm³ or higher and a relative density of 95% or more.

### CROSS-REFERENCE TO RELATED APPLICATIONS

This application claims the priority of Korean Patent Application No. 10-2013-0015352 filed on Feb. 13, 2013, in the Korean Intellectual Property Office, the disclosure of which is incorporated herein by reference.

### BACKGROUND OF THE INVENTION

1. Field of the Invention

The present invention relates to a conductive paste composition, a multilayer ceramic capacitor using the same, and a method of manufacturing the multilayer ceramic capacitor using the same.

2. Description of the Related Art

As electric and electronic devices are provided with higher levels of functionality and become ever lighter, thinner, and smaller, electronic components are also required to have smaller sizes, higher levels of performance, and lower prices.

In particular, as CPU speeds increase and devices to which they are applied become smaller, lighter, digitalized and more highly-functionalized, research and development of multilayer ceramic capacitors aimed at realizing characteristics such as miniaturization, thinness, higher capacitance, lower impedance in high frequency bands, and the like, have been actively progressed.

In order to realize the miniaturization and higher capacitance required in the fields of electric and electronic devices, it is necessary to use a material having high permittivity, increase an overlapping area of facing internal electrodes, and decrease a distance between neighboring internal electrodes.

Therefore, thinness in the internal electrodes is required in order to realize high capacitance in the multilayer ceramic capacitor.

In the related art, multilayer ceramic capacitors have a structure in which dielectric layers and internal electrodes are alternately laminated. Here, the dielectric layers are formed of a ceramic material; the internal electrodes are formed of a metal having a high degree of conductivity; and external electrodes are formed of metal such as copper (Cu).

A multilayer ceramic capacitor is manufactured by coating a conductive paste for internal electrodes on dielectric layers, and then laminating and sintering the same.

When the dielectric layers on which the conductive paste for internal electrodes is coated are sintered, cracks may occur due to a difference in sintering shrinkage rates of the internal electrodes and the dielectric layers.

In the case in which cracks occur, electrode connectivity may be deteriorated, causing a reduction in capacitance, while short circuits may occur, resulting in deteriorated reliability.

Therefore, technology for lowering the occurrence of cracks is required.

The following Patent Documents are directed to a conductive paste for internal electrodes of a multilayer ceramic capacitor. However, these patent documents fail to disclose a highly dense conductive paste.

### RELATED ART DOCUMENTS

(Patent Document 1) Korean Patent Laid-Open Publication No. 2011-0077788
(Patent Document 2) Japanese Patent Laid-Open Publication No. 2010-056290

### SUMMARY OF THE INVENTION

An aspect of the present invention provides a highly dense conductive paste and a high-capacitance multilayer ceramic capacitor using the same.

According to an aspect of the present invention, there is provided a conductive paste composition, including: a conductive metal powder; a ceramic powder; and a resin, wherein the conductive paste composition has a theoretical density of 6 g/cm³ or higher and a relative density of 95% or more.

The ceramic powder may be contained in an amount of 5 to 10 wt %.

The resin may be contained in an amount of 3 to 5 wt %.

The ceramic powder may include at least one selected from the group consisting of BaTiO₃, Ba(TiZr)O₃, CaZrO₃, and SrZrO₃.

The resin may be at least one of polyvinyl butyral (PVB) and ethyl cellulose (EC).

The conductive metal powder maybe at least one selected from the group consisting of silver (Ag), lead (Pb), platinum (Pt), nickel (Ni), and copper (Cu).

According to another aspect of the present invention, there is provided a multilayer ceramic capacitor, including: a ceramic body having dielectric layers laminated therein; internal electrodes formed on the dielectric layers, the internal electrodes being formed of a conductive paste composition containing a conductive metal powder, a ceramic powder, and a resin, and having a theoretical density of 6 g/cm³ or higher and a relative density of 95% or more; and external electrodes formed on outer surfaces of the ceramic body and electrically connected to the internal electrodes.

The ceramic powder may be contained in an amount of 5 to 10 wt %.

The resin may be contained in an amount of 3 to 5 wt %.

The ceramic powder may include at least one selected from the group consisting of BaTiO₃, Ba(TiZr)O₃, CaZrO₃, and SrZrO₃.

The resin may be at least one of polyvinyl butyral (PVB) and ethyl cellulose (EC).

The conductive metal powder maybe at least one selected from the group consisting of silver (Ag), lead (Pb), platinum (Pt), nickel (Ni), and copper (Cu).

The dielectric layer may have a thickness of 1.0 to 6. 0 μm.

The internal electrode may have a thickness of 1.0 μm or less.

According to another aspect of the present invention, there is provided a method of manufacturing a multilayer ceramic capacitor, the method including: preparing a conductive paste composition containing a conductive metal powder, a ceramic powder, and a resin, and having a theoretical density of 6 g/cm³ or higher and a relative density of 95% or more; forming internal electrodes using the conductive paste composition on a plurality of green sheets, respectively; forming a laminate by laminating the green sheets on which the internal electrodes are formed; manufacturing a green chip by using the laminate; and sintering the green chip to manufacture a ceramic body.

The ceramic powder may be contained in an amount of 5 to 10 wt %.

The resin may be contained in an amount of 3 to 5 wt %.

The ceramic powder may include at least one selected from the group consisting of BaTiO₃, Ba(TiZr)O₃, CaZrO₃, and SrZrO₃.

The resin may be at least one of polyvinyl butyral (PVB) and ethyl cellulose (EC).

The conductive metal powder maybe at least one selected from the group consisting of silver (Ag), lead (Pb), platinum (Pt), nickel (Ni), and copper (Cu).

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A and 1B are images for comparing printing forms of a multilayer ceramic capacitor according to an embodiment of the present invention (FIG. 1B) and a multilayer ceramic capacitor of the related art (FIG. 1A);

FIGS. 2A and 2B are images for comparing internal electrode connectivity of the multilayer ceramic capacitor according to an embodiment of the present invention (FIG. 2B) and the multilayer ceramic capacitor of the related art (FIG. 2A);

FIGS. 3A and 3B are graphs for comparing IR characteristics of the multilayer ceramic capacitor according to an embodiment of the present invention (FIG. 3B) and the multilayer ceramic capacitor of the related art (FIG. 3A);

FIG. 4 is a perspective view schematically showing the multilayer ceramic capacitor according to an embodiment of the present invention; and

FIG. 5 is a cross-sectional view taken along line A-A′ of FIG. 4.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

A conductive paste composition according to an embodiment of the invention may include a conductive metal powder; a ceramic powder; and a resin, and have a theoretical density of 6 g/cm³ or higher and a relative density of 95% or more.

A highly dense conductive paste composition herein refers to a conductive paste composition having a theoretical density of 6 g/cm³ or higher and a relative density of 95% or more.

Hereinafter, respective components of the conductive paste composition according to an embodiment of the invention will be described in greater detail.

The conductive metal powder is not particularly limited, and for example, may be silver (Ag), lead (Pb), platinum (Pt), nickel (Ni), or copper (Cu), used alone or in a mixture of two or more thereof.

In addition, the conductive metal powder may have various average particle sizes depending on the embodiments of the invention, and for example, may have an average particle size of 50 to 400 nm.

If the average particle size of the metal powder is below 50 nm, it may be difficult to control shrinkage of the metal powder at the time of sintering. If the average particle size of the metal powder is above 400 nm, it maybe difficult to make internal electrode layers thin.

Meanwhile, a method of dispersing the metal powder in the conductive paste composition is not particularly limited, and for example, the metal powder may be dispersed in the conductive paste composition with a three roll mill.

The resin is not particularly limited, and for example, at least one or a mixture of polyvinyl butyral (PVB) and ethyl cellulose (EC) may be used.

The resin plays a very important role in determining characteristics of the paste.

First, the resin serves as a dispersion assistant providing fluidity and phase stability to the paste in a paste dispersing process.

Second, the resin serves to level a printed paste surface by viscoelastic behavior thereof in a process in which the paste is printed on a ceramic green sheet in order to manufacture a multilayer ceramic capacitor.

If the printed paste surface is not level, short circuits may occur between internal electrodes or the internal electrodes maybe disconnected while a plurality of green sheets on which the paste is printed are laminated and compressed, resulting in decreased capacitance and deteriorated reliability of the multilayer ceramic capacitor.

Lastly, the resin serves as an adhesive providing adhesive strength between dielectric layers and internal electrodes in a lamination process of a plurality of green sheets on which the paste is printed.

The ceramic powder is not particularly limited as long as the ceramic powder can control sintering shrinkage of a metal powder, and for example, may be at least one selected from the group consisting of BaTiO₃, Ba(TiZr)O₃, CaZrO₃, and SrZrO₃.

The method of dispersing the ceramic powder in the conductive paste is not particularly limited, and for example, the ceramic powder may be dispersed by using a bead mill.

The ceramic powder may have various average particle sizes depending on the embodiments of the invention, and for example, may have an average particle size of 10 to 200 nm.

The average particle size of the ceramic powder may be determined in proportion to the average particle size of the metal powder, and preferably, may be 10 to 200 nm as described above.

The conductive paste composition may have a theoretical density of 6 g/cm³ or higher and a relative density of 95% or more.

Density refers to a value obtained by dividing mass of an object or a material by volume thereof.

Theoretical density refers to density of a mixture or a compound calculated by using respective theoretical density values of materials contained in the mixture or the compound.

Actual density is another term for measured density, and refers to a density value measured by the Archimedes method.

Relative density refers to a ratio of actual (measured) density and theoretical density, and is expressed by using percentage (%) in the present specification.

The theoretical density and relative density of the conductive paste composition were measured by controlling respective amounts of the ceramic powder and the resin in the conductive paste composition.

Conductive paste compositions having different respective amounts of ceramic powder and resin were used to manufacture multilayer ceramic capacitors.

Capacitance, occurrence or nonoccurrence of short circuits, occurrence or nonoccurrence of delamination, and electrode connectivity of the individual manufactured multilayer ceramic capacitors were tabulated in Table 1 below.

TABLE 1

| Ceramic | | | | | Short | | |
|---|---|---|---|---|---|---|---|
| Powder | Resin | Theoretical | Relative | | Circuit | Electrode | Delamination |
| (wt %) | (wt %) | Density | Density | Capacitance | Occurrence | Connectivity | Occurrence |
| 5 | 2 | ∘ | ∘ | ∘ | x | ∘ | x |
| 10 | 2 | ∘ | ∘ | ∘ | x | ∘ | x |
| 20 | 2 | ∘ | ∘ | ∘ | x | ∘ | x |
| 30 | 2 | ∘ | x | x | x | ∘ | x |
| 5 | 3 | ∘ | ∘ | ∘ | ∘ | ∘ | ∘ |
| 10 | 3 | ∘ | ∘ | ∘ | ∘ | ∘ | ∘ |
| 20 | 3 | ∘ | ∘ | ∘ | x | ∘ | x |
| 30 | 3 | ∘ | x | x | x | ∘ | x |
| 5 | 5 | ∘ | ∘ | ∘ | ∘ | ∘ | ∘ |
| 10 | 5 | ∘ | ∘ | ∘ | ∘ | ∘ | ∘ |
| 20 | 5 | ∘ | x | ∘ | ∘ | ∘ | ∘ |
| 30 | 5 | ∘ | x | x | ∘ | ∘ | ∘ |
| 5 | 10 | x | x | x | ∘ | x | ∘ |
| 10 | 10 | x | x | x | ∘ | x | ∘ |
| 20 | 10 | x | x | x | ∘ | x | ∘ |
| 30 | 10 | x | x | x | x | x | ∘ |

Here, 100 multilayer ceramic capacitors manufactured according to varied amounts of common material and resin were tested, and ∘ or × was marked according to the test results.

∘ denotes delamination occurring in less than 2 of 100 multilayer ceramic capacitors and × denotes 2 or more thereof.

∘ denotes capacitance of 95% or more of desired capacitance and × denotes less than 95% thereof.

∘ denotes theoretical density of 6 g/cm³ or higher and × denotes lower than 6 g/cm³ thereof.

∘ denotes relative density of 95% or more and × denotes less than 95% thereof.

∘ denotes short circuits occurring in less than 2 of 100 multilayer ceramic capacitors and × denotes 2 or more thereof.

∘ denotes electrode connectivity of 85% or more and × denotes less than 85% thereof.

As shown in Table 1, when a theoretical density of the conductive paste composition is 6 g/cm³ or higher and a relative density thereof is 95% or more, a low rate of delamination is present and sufficient capacitance is secured, and thus, a multilayer ceramic capacitor having superior electrode connectivity can be manufactured.

Also, when a theoretical density of the conductive paste composition is 6 g/cm³ or higher and a relative density thereof is 95% or more, there are very few multilayer ceramic capacitors in which short circuits occur, and thus, reliability of the multilayer ceramic capacitors can be secured.

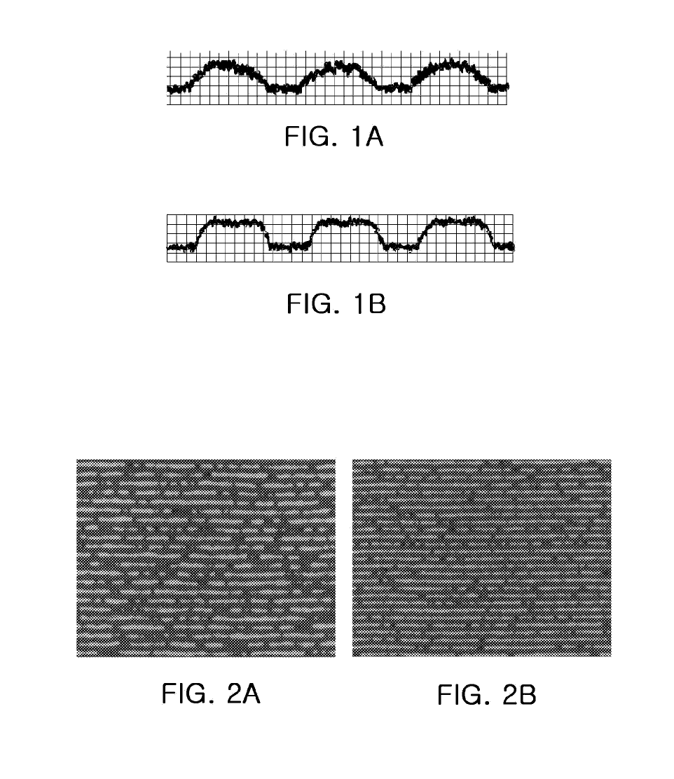

FIGS. 1A and 1B are images comparing printing forms of a multilayer ceramic capacitor according to an embodiment of the invention (B) and a multilayer ceramic capacitor of the related art (A).

It may be seen from FIGS. 1A and 1B that the printing form was improved in the case in which a theoretical density of the conductive paste composition was 6 g/cm³ or higher and a relative density thereof was 95% or more (FIG. 1B) than in the related art (FIG. 1A).

Therefore, the multilayer ceramic capacitor manufactured by using the conductive paste composition according to the embodiment of the invention has higher reliability than the multilayer ceramic capacitor manufactured according to the related art.

FIGS. 2A and 2B are images for comparing internal electrode connectivity of the multilayer ceramic capacitor according to the embodiment of the invention (FIG. 2B) and the multilayer ceramic capacitor of the related art (FIG. 2A).

It may be seen from FIGS. 2A and 2B that the internal electrode connectivity was better in the case in which a theoretical density of the conductive paste composition was 6 g/cm³ or higher and a relative density thereof was 95% or more (FIG. 2B) than in the related art (FIG. 2A).

Therefore, the number of internal electrodes contributing to capacitance of a multilayer ceramic capacitor is increased in the multilayer ceramic capacitor manufactured by using the conductive paste composition according to the embodiment of the invention as compared with the multilayer ceramic capacitor manufactured by the related art.

That is, as electrode connectivity increases, an overlapping area of the internal electrodes is further increased, and thus the capacitance of the multilayer ceramic capacitor is increased.

In addition, as electrode connectivity increases, short circuits occurring between the internal electrodes are decreased, and thus reliability of the multilayer ceramic capacitor is improved.

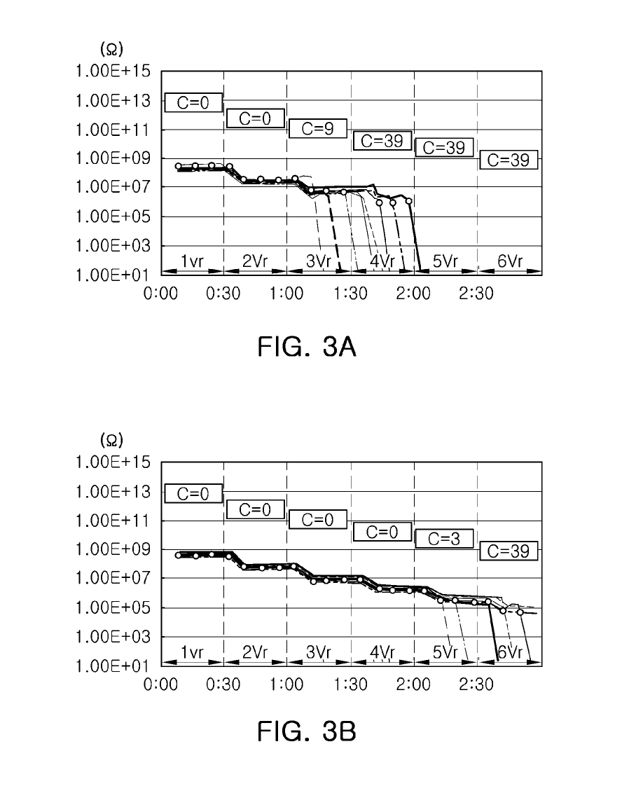

FIGS. 3A and 3B are graphs for comparing IR characteristics of the multilayer ceramic capacitor according to an embodiment of the invention (FIG. 3B) and the multilayer ceramic capacitor of the related art (FIG. 3A).

FIGS. 3A and 3B show stepwise IR measurement results of the multilayer ceramic capacitor taken in respective operations from 1 Vr to 6 Vr in which the multilayer ceramic capacitor was maintained at 130° C. for 30 minutes.

It may be seen from FIGS. 3A and 3B that IR characteristics were further improved by 2 Vr in the case in which a theoretical density of the conductive paste composition was 6 g/cm³ or higher and a relative density thereof was 95% or more (FIG. 3B) than in the related art (FIG. 3A).

Particularly, it may be seen that the accumulative occurrence of malfunctions (C) was increased from 5 Vr in the multilayer ceramic capacitor according to the embodiment of the invention (FIG. 3B), but was increased from 3 Vr in the related art (FIG. 3A).

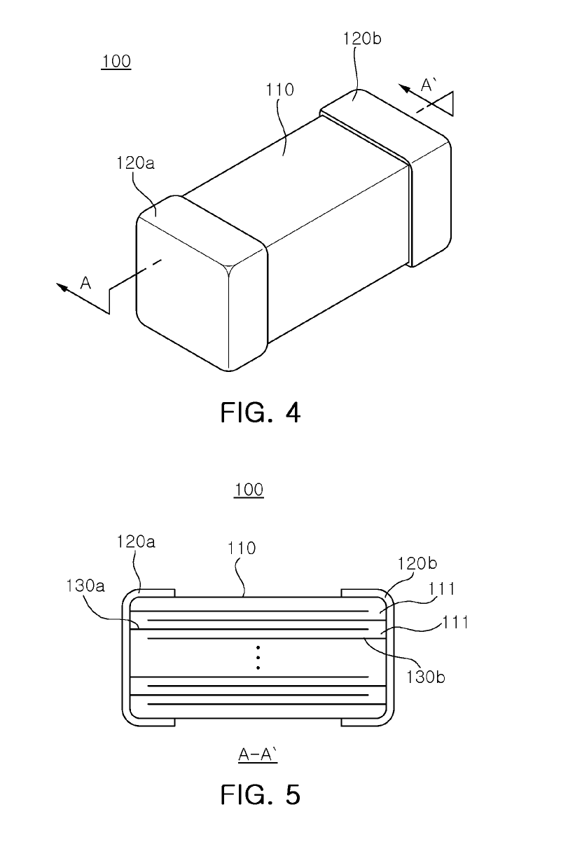

FIG. 4 is a perspective view schematically showing a multilayer ceramic capacitor according to an embodiment of the invention; and FIG. 5 is a cross-sectional view taken along line A-A′ of FIG. 4.

Referring to FIGS. 4 and 5, a multilayer ceramic capacitor 100 according to another embodiment of the invention may include: a ceramic body 110 having dielectric layers 111 laminated therein; internal electrodes 130a and 130b formed on the dielectric layers 111, respectively, the internal electrodes being formed of a conductive paste composition containing a conductive metal powder, a ceramic powder, and a resin, and having a theoretical density of 6 g/cm³ or higher and a relative density of 95% or more; and external electrodes 120a and 120b formed on outer surfaces of the ceramic body 110 and electrically connected to the internal electrodes.

The ceramic body 110 may be formed by laminating and sintering the plurality of dielectric layers 111, and here, adjacent dielectric layers may be integrated with one another.

The dielectric layers 111 may be formed of a ceramic material having high permittivity, but is not particularly limited. For example, the ceramic dielectric layers 111 may be formed by using a barium titanate (BaTiO₃) based material, a lead-complex perovs kite based material, a strontium titanate (SrTiO₃) based material, or the like.

The internal electrodes 130a and 130b may be disposed between the dielectric layers in a process in which the plurality of dielectric layers are laminated, and may be formed to have the dielectric layer interposed therebetween inside the ceramic body through sintering.

One ends of the internal electrodes 130a and 130b are alternately exposed to both end surfaces of the ceramic body.

One ends of the internal electrodes 130a and 130b exposed to both end surfaces of the ceramic body are electrically connected to the external electrodes 120a and 120b, respectively.

The internal electrodes 130a and 130b are formed of the conductive paste composition according to the embodiment of the invention.

Since the conductive paste composition according to the embodiment of the present invention is in a highly dense state and thus has a theoretical density of 6 g/cm³ or higher and a relative density of 95% or more, the printing characteristics of the internal electrodes are improved and the connectivity thereof is increased, resulting in increased capacitance and improved reliability.

In a method of manufacturing a multilayer ceramic capacitor according to another embodiment of the invention, the method may include preparing a conductive paste composition containing a conductive metal powder, a ceramic powder, and a resin, and having a theoretical density of 6 g/cm³ or higher and a relative density of 95% or more; forming internal electrodes using the conductive paste composition on a plurality of green sheets, respectively; forming a laminate by laminating the green sheets on which the internal electrodes are respectively formed; manufacturing a green chip by using the laminate; and sintering the green chip to manufacture a ceramic body.

First, a conductive paste composition having a theoretical density of 6 g/cm or higher and a relative density of 95% or more may be prepared.

Then, the multilayer ceramic capacitor 100 is manufactured by using the conductive paste, and a manufacturing process of the multilayer ceramic capacitor 100 will be described below.

First, a plurality of green sheets may be prepared.

The ceramic green sheets may be fabricated by mixing a ceramic powder, a binder, and a solvent to prepare a slurry, and then forming the slurry into a sheet having a thickness of several μm using a doctor blade method.

Then, the internal electrodes 130a and 130b may be respectively formed on the ceramic green sheets with the conductive paste.

The conductive paste is a conductive paste according to an embodiment of the present invention, and patterns of the first and second internal electrodes maybe formed by a gravure printing method.

As such, after the internal electrodes 130a and 130b are formed, the green sheets are separated from carrier films, and then the plurality of green sheets are laminated while overlapping each other, to thereby form a green sheet laminate.

Then, the green sheet laminate is compressed at a high temperature and a high pressure, and is then cut to have a predetermined size, thereby manufacturing green chips.

After that, plasticizing, sintering, and polishing are carried out to manufacture the ceramic body 110, and then a process of forming the external electrodes 120a and 120b and a plating process are carried out to complete the multilayer ceramic capacitor 100.

The internal electrodes 130a and 130b are formed of the conductive paste composition according to the embodiment of the invention.

Since the conductive paste composition according to the embodiment of the invention is in a highly dense state and thus has a theoretical density of 6 g/cm³ or higher and a relative density of 95% or more, the printing form characteristics of the internal electrodes are improved and the connectivity thereof is increased, resulting in increased capacitance and improved reliability.

As set forth above, according to embodiments of the invention, a highly dense conductive paste is used to form internal electrodes of a multilayer ceramic capacitor, thereby improving capacitance and reliability of the multilayer ceramic capacitor.

Specifically, theoretical density and relative density of the conductive paste are increased, to thereby densify the internal electrodes of the multilayer ceramic capacitor and thus make the internal electrodes uniform, so that electrode connectivity is improved and an overlapping area between electrodes is increased, thereby improving capacitance and reliability of the multilayer ceramic capacitor.

While the present invention has been shown and described in connection with the embodiments, it will be apparent to those skilled in the art that modifications and variations can be made without departing from the spirit and scope of the invention as defined by the appended claims.

What is claimed is:

1. A conductive paste composition, comprising:
a conductive metal powder;
a ceramic powder; and
a resin,
wherein the conductive paste composition has a theoretical density of 6 g/cm³ or higher and a relative density of 95% or more.

2. The conductive paste composition of claim 1, wherein the ceramic powder is contained in an amount of 5 to 10 wt %.

3. The conductive paste composition of claim 1, wherein the resin is contained in an amount of 3 to 5 wt %.

4. The conductive paste composition of claim 1, wherein the ceramic powder includes at least one selected from the group consisting of BaTiO₃, Ba(TiZr)O₃, CaZrO₃, and SrZrO₃.

5. The conductive paste composition of claim 1, wherein the resin is at least one of polyvinyl butyral (PVB) and ethyl cellulose (EC).

6. The conductive paste composition of claim 1, wherein the conductive metal powder is at least one selected from the group consisting of silver (Ag), lead (Pb), platinum (Pt), nickel (Ni), and copper (Cu).

7. A multilayer ceramic capacitor, comprising:
a ceramic body having dielectric layers laminated therein;
internal electrodes formed on the dielectric layers, the internal electrodes being formed of a conductive paste composition containing a conductive metal powder, a ceramic powder, and a resin, and having a theoretical density of 6 g/cm³ or higher and a relative density of 95% or more; and
external electrodes formed on outer surfaces of the ceramic body and electrically connected to the internal electrodes.

8. The multilayer ceramic capacitor of claim 7, wherein the ceramic powder is contained in an amount of 5 to 10 wt %.

9. The multilayer ceramic capacitor of claim 7, wherein the resin is contained in an amount of 3 to 5 wt %.

10. The multilayer ceramic capacitor of claim 7, wherein the ceramic powder includes at least one selected from the group consisting of BaTiO₃, Ba (TiZr)O₃, CaZrO₃, and SrZrO₃.

11. The multilayer ceramic capacitor of claim 7, wherein the resin is at least one of polyvinyl butyral (PVB) and ethyl cellulose (EC).

12. The multilayer ceramic capacitor of claim 7, wherein the conductive metal powder is at least one selected from the group consisting of silver (Ag), lead (Pb), platinum (Pt), nickel (Ni), and copper (Cu).

13. The multilayer ceramic capacitor of claim 7, wherein the dielectric layer has a thickness of 1.0 to 6.0 μm.

14. The multilayer ceramic capacitor of claim 7, wherein the internal electrode has a thickness of 1.0 μm or less.

15. A method of manufacturing a multilayer ceramic capacitor, the method comprising:
preparing a conductive paste composition containing a conductive metal powder, a ceramic powder, and a resin, and having a theoretical density of 6 g/cm³ or higher and a relative density of 95% or more;
forming internal electrodes using the conductive paste composition on a plurality of green sheets, respectively;
forming a laminate by laminating the green sheets on which the internal electrodes are formed;
manufacturing a green chip by using the laminate; and
sintering the green chip to manufacture a ceramic body.

16. The method of claim 15, wherein the ceramic powder is contained in an amount of 5 to 10 wt %.

17. The method of claim 15, wherein the resin is contained in an amount of 3 to 5 wt %.

18. The method of claim 15, wherein the ceramic powder includes at least one selected from the group consisting of BaTiO₃, Ba(TiZr)O₃, CaZrO₃, and SrZrO₃.

19. The method of claim 15, wherein the resin is at least one of polyvinyl butyral (PVB) and ethyl cellulose (EC).

20. The method of claim 15, wherein the conductive metal powder is at least one selected from the group consisting of silver (Ag), lead (Pb), platinum (Pt), nickel (Ni), and copper (Cu).
